(19) United States
(12) Patent Application Publication
(10) Pub. No.: US 2020/0000103 A1
(43) Pub. Date: Jan. 2, 2020

(54) Automated Mechanism for Producing a Baked or Fried Product, Including Methods of Production

(71) Applicant: Steven-Robert Originals, LLC, Aurora, CO (US)

(72) Inventors: Brian McGuire, Aurora, CO (US); Jonathan Cole Lewis, Firestone, CO (US)

(73) Assignee: Steven-Robert Originals, LLC, Aurora, CO (US)

(21) Appl. No.: 16/564,450

(22) Filed: Sep. 9, 2019

Related U.S. Application Data
(63) Continuation-in-part of application No. 14/864,368, filed on Sep. 24, 2015, now abandoned.

(51) Int. Cl. A21B 3/13; A47J 37/12; A21D 13/31; A21D 13/20; A21D 13/60; A21D 13/80

(52) U.S. Cl. CPC A21B 3/13; A47J 37/1295; A21D 13/31; A23V 2002/00; A21D 13/60; A21D 13/80; A21D 13/20

(57) ABSTRACT

Mechanisms and methods for producing a baked or fried cake product are disclosed herein that include: a mold, a product handle insertion mechanism, a dipping tray, wherein the dipping tray is designed to hold a plurality of the baked or fried cake products, a robotic tool, an open container of a liquid coating material, a robotic dipping tool, wherein the dipping tool is designed to place the full dipping tray into the container of the liquid coating material and then remove the full dipping tray from the container after the baked or fried cake product is coated, and a drying station.

This United States Continuation patent application claims priority to U.S. Utility application Ser. No. 14/864,368, which was filed on Sep. 24, 2015 and which is commonly-owned and incorporated herein in its entirety.

### FIELD OF THE SUBJECT MATTER

The field of the subject matter is systems for producing a baked or fried product, including the methods of production.

### BACKGROUND

Automated systems and mechanisms for producing baked and fried products have advanced throughout the years. In many of these systems, doughs or batters are formed or put in molds, baked and then manipulated, such as by adding fillings, handles or a combination thereof. When these products need to be coated or decorated, they are usually fed into a waterfall-type of system, where the product moves or transitions below a liquid coating that is continuously falling and then being recirculated. In some instances, each individual product is dipped into a liquid coating material in a process that requires significant infrastructure.

To this end, it would be desirable to develop, produce and utilize an automated system for producing a baked or fried product, wherein that product includes a stick so that the consumer can easily hold the product and wherein that product is coated with at least one coating material and may be additionally decorated.

### SUMMARY OF THE SUBJECT MATTER

Mechanisms for producing a baked or fried cake product are disclosed herein that include: a mold, wherein the mold comprises a top half, a bottom half and an end opening and wherein the mold is designed to hold a raw dough or batter product, a product handle insertion mechanism, wherein a handle is inserted into the raw dough or batter product, a heating element, wherein the heating element is designed to bake the raw dough or batter product or heat oil to fry the raw dough or batter product to form a baked or fried cake product, a dipping tray, wherein the dipping tray is designed to hold a plurality of the baked or fried cake product, a robotic tool, wherein the tool is designed to grab the handle in the baked or fried cake product and move the baked or fried cake product to the dipping tray, an open container of a liquid coating material, a robotic dipping tool, wherein the dipping tool is designed to place the full dipping tray into the container of the liquid coating material and then remove the full dipping tray from the container after the baked or fried cake product is coated, and a drying station, wherein the drying station is designed to secure the full dipping tray until the coated baked or fried cake product is dried.

Methods for producing a baked or fried cake product are disclosed herein that include: providing a mold, wherein the mold comprises a top half, a bottom half and an end opening and wherein the mold is designed to hold a raw dough or batter product, providing a product handle insertion mechanism, wherein a handle is inserted into the raw dough or batter product, providing a heating element, wherein the heating element is designed to bake the raw dough or batter product or heat oil to fry the raw dough or batter product to form a baked or fried cake product, providing a dipping tray, wherein the dipping tray is designed to hold a plurality of the baked or fried cake product, providing a robotic tool, wherein the tool is designed to grab the handle in the baked or fried cake product and move the baked or fried cake product to the dipping tray, providing an open container of a liquid coating material, providing a robotic dipping tool, wherein the dipping tool is designed to place the full dipping tray into the container of the liquid coating material and then remove the full dipping tray from the container after the baked or fried cake product is coated, and providing a drying station, wherein the drying station is designed to secure the full dipping tray until the coated baked or fried cake product is dried.

### BRIEF DESCRIPTION OF THE FIGURES

FIG. 1 shows a contemplated mechanism for producing a baked or fried cake product.

FIG. 2 shows a contemplated method for producing a baked or fried cake product.

FIG. 3 shows a contemplated bottom half of a mold, wherein there are a number of mold bottom halves that form part of a mold assembly.

FIG. 4 shows a contemplated top half of a mold with an end opening, wherein there are a number of mold bottom halves that form part of a mold assembly. A stick is shown as part of this Figure as well inserted into the end opening of one mold.

FIG. 5 shows a side perspective of the contemplated bottom half of the mold of FIG. 3 mated with the contemplated top half of the mold of FIG. 4. A stick is shown as part of this Figure as well inserted into the end opening of one mold. The product produced in this embodiment is square or rectangular.

FIG. 6 shows a contemplated baked or fried cake product 625 from the front 630, the side 640 and from a diagonal perspective 650. The stick 660 is shown in each embodiment as well. Contemplated relative dimensions are shown as well in this Figure, although these contemplated relative dimensions may be different for each product 625. The product here is considered rectangular, square or a combination of shapes.

FIG. 7 shows the back end of the above-contemplated method that shows a heating element 705, a baked or fried cake product 710, providing a dipping tray 720, wherein the dipping tray is designed to hold a plurality of the baked or fried cake product 710, providing a robotic tool 730, wherein the tool 730 is designed to grab the handle 740, the stick or the post in the baked or fried cake product 710 and move the baked or fried cake product to the dipping tray 720.

### DETAILED DESCRIPTION

A mechanism and related method has been developed that utilizes an automated system for producing a baked or fried product, wherein that product includes a stick so that the consumer can easily hold the product and wherein that product is coated with at least one coating material and may be additionally decorated.

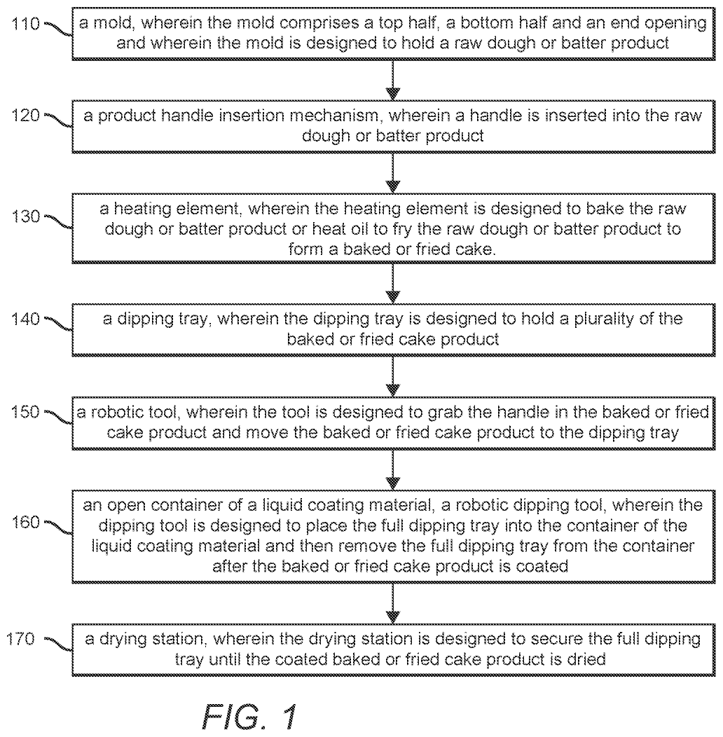

Specifically, mechanisms for producing a baked or fried cake product are disclosed, shown in FIG. 1 and described in detail herein that include: a mold, wherein the mold comprises a top half, a bottom half and an end opening and wherein the mold is designed to hold a raw dough or batter product 110, a product handle insertion mechanism, wherein a handle is inserted into the raw dough or batter product 120, a heating element, wherein the heating element is designed to bake the raw dough or batter product or heat oil to fry the raw dough or batter product to form a baked or fried cake product 130, a dipping tray, wherein the dipping tray is designed to hold a plurality of the baked or fried cake product 140, a robotic tool, wherein the tool is designed to grab the handle in the baked or fried cake product and move the baked or fried cake product to the dipping tray 150, an open container of a liquid coating material, a robotic dipping tool, wherein the dipping tool is designed to place the full dipping tray into the container of the liquid coating material and then remove the full dipping tray from the container after the baked or fried cake product is coated 160, and a drying station, wherein the drying station is designed to secure the full dipping tray until the coated baked or fried cake product is dried 170.

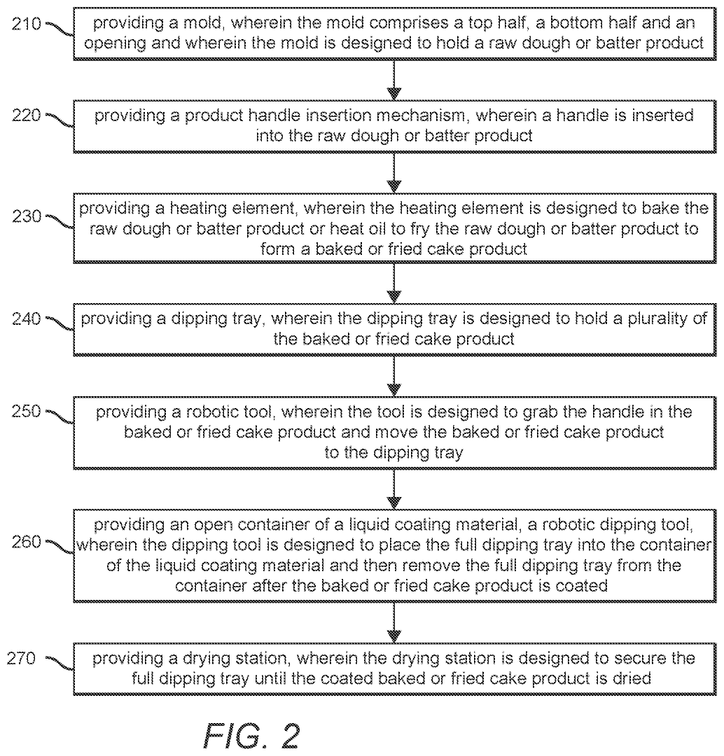

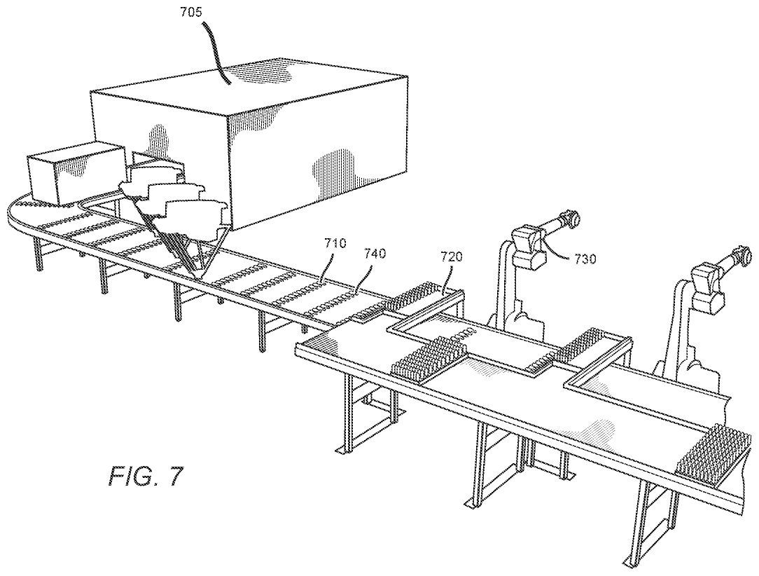

Methods of producing a baked or fried cake product are shown in FIG. 2 and include: providing a mold, wherein the mold comprises a top half, a bottom half and an end opening and wherein the mold is designed to hold a raw dough or batter product 210, providing a product handle insertion mechanism, wherein a handle, a stick or a post is inserted into the raw dough or batter product 220, providing a heating element, wherein the heating element is designed to bake the raw dough or batter product or heat oil to fry the raw dough or batter product to form a baked or fried cake product 230, providing a dipping tray, wherein the dipping tray is designed to hold a plurality of the baked or fried cake product 240, providing a robotic tool, wherein the tool is designed to grab the handle, the stick or the post in the baked or fried cake product and move the baked or fried cake product to the dipping tray 250, providing an open container of a liquid coating material, providing a robotic dipping tool, wherein the dipping tool is designed to place the full dipping tray into the container of the liquid coating material and then remove the full dipping tray from the container after the baked or fried cake product is coated 260, and providing a drying station, wherein the drying station is designed to secure the full dipping tray until the coated baked or fried cake product is dried 270. These methods may further include injecting a filling into the raw dough or batter before the dough or batter is baked or fried. FIG. 7 shows the back end of the above-contemplated method that shows a baked or fried cake product 710, providing a dipping tray 720, wherein the dipping tray is designed to hold a plurality of the baked or fried cake product 710, providing a robotic tool 730, wherein the tool 730 is designed to grab the handle 740, the stick or the post in the baked or fried cake product 710 and move the baked or fried cake product to the dipping tray 720.

As contemplated, mechanisms for producing a baked or fried cake product include a mold, wherein the mold comprises a top half, a bottom half and an end opening and wherein the mold is designed to hold a raw dough or batter product. Contemplated molds may comprise any suitable shape for a baked or fried product, as long as the final product is able to be supported by a handle, stick or post, which will be described later. Contemplated molds may be rectangular, square, spherical, triangular or a combination of shapes, depending on the needs of the product and the producer. Contemplated molds may be made from any suitable material or materials, as long as they are capable of being heated to and at temperatures that are necessary to bake or fry a dough or cake product from raw or batter form to fully cooked. Contemplated mold materials may comprise aluminum, steel, cast iron, non-stick material, composite material or a combination thereof.

As mentioned, contemplated molds comprise a top half, a bottom half and an end opening. The top and bottom halves may be independent from one another—in that they can be separated from one another to remove the product, or they may be one piece of material designed so that the product slides out of it or is easily removed. The end opening is primarily designed to allow a handle, stick or post to be easily inserted into the raw dough or uncooked batter before the product is baked or fried. The end opening may also be large enough for the product to slide out of the mold after frying or baking. Contemplated molds may also comprise a texture or patterning, so that the finished dough or cake product has a textured or patterned surface.

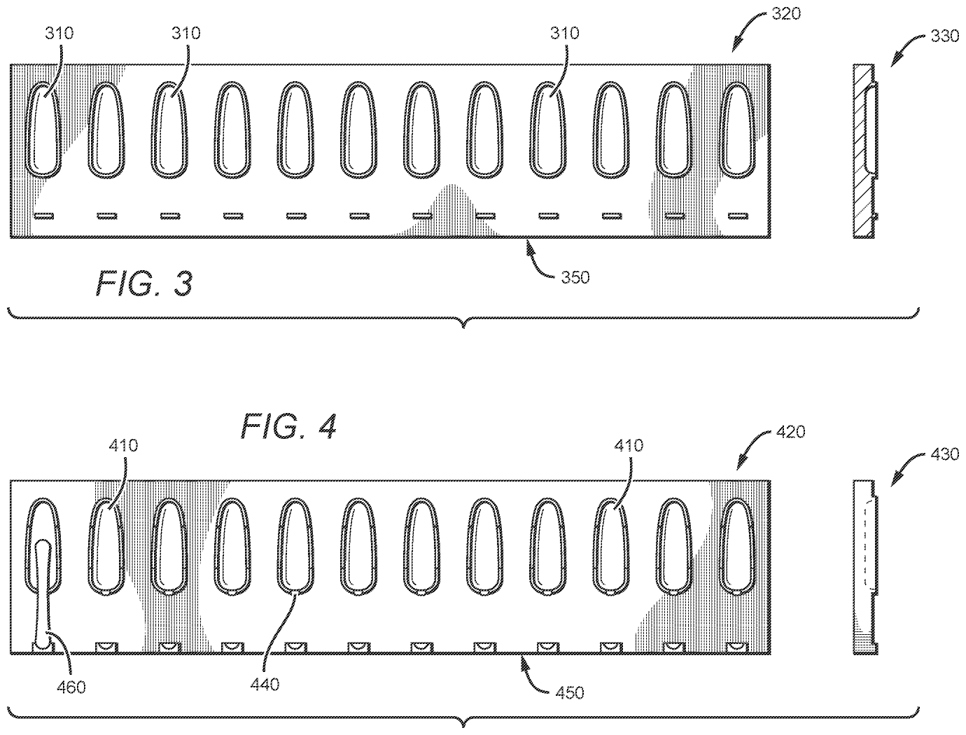

FIG. 3 shows a contemplated bottom half 310 of a mold from a flat perspective 320 and a side perspective 330, wherein there are a number of mold bottom halves 310 that form part of a mold assembly 350.

FIG. 4 shows a contemplated top half 410 of a mold from a flat perspective 420 and a side perspective 430 with an end opening 440, wherein there are a number of mold bottom halves 410 that form part of a mold assembly 450. A stick 460 is shown as part of this Figure as well inserted into the end opening 440 of one mold.

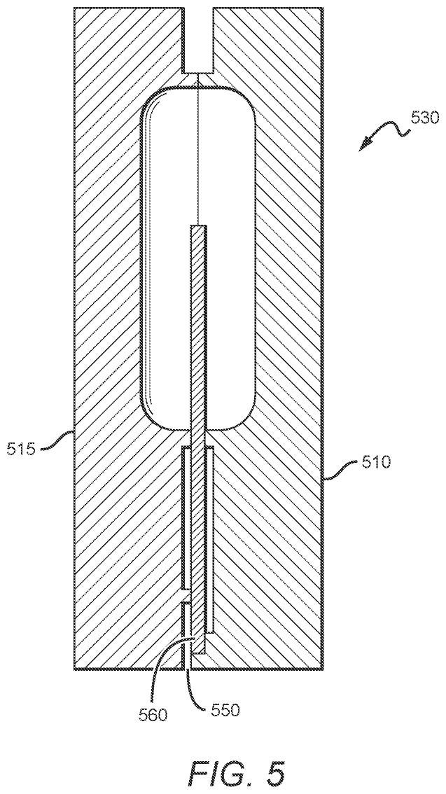

FIG. 5 shows a side perspective 530 of the contemplated bottom half 510 of the mold of FIG. 3 mated with the contemplated top half 515 of the mold of FIG. 4. A stick 560 is shown as part of this Figure as well inserted into the end opening 550 of one mold.

Contemplated mechanisms also include a product handle insertion mechanism, wherein a handle is inserted into the raw dough or batter product. In most embodiments, the product handle insertion mechanism is fully automated and controlled by robots and/or computers. In some embodiments, the product handle insertion mechanism is partially or partly automated, in that the mechanism may include some manual steps. The mechanism operates to pick up handles, sticks or posts and reliably insert the handle, stick or post in each of the raw dough or batter products. This process is unique, because the handle, stick or post is inserted into the raw dough or batter before the product is baked or fried. It should be understood that the end opening of each mold is designed to operatively communicate with each handle, in that the end opening acts as a general guide for each handle into the dough or batter.

In some embodiments, a filling may also be injected into the raw dough or batter before the handle, stick or post is inserted and before the dough or batter is baked or fried. This process is something new in the art, as most fillings are injected after the dough or batter is fully cooked, baked or fried.

In contemplated embodiments, the handle, post or stick is inserted in the raw batter, the raw batter is cooked, and then the robotic tool grabs the handle, the stick or the post in the baked or fried cake product and move the baked or fried cake product to the dipping tray. Conventional embodiments utilize the robotic tool to put the product in the dipping tray. In contemplated embodiments, the robotic dipping tool places the full dipping tray into the container of the liquid coating material and then remove the full dipping tray from the container after the baked or fried cake product is coated. This arrangement is not taught, suggested or disclosed to one of ordinary skill in the art at all. One of ordinary skill in the art would see the skewer of conventional apparatus or methods as inserted into solid food products to hold them, while the food product is battered and then cooked or dipped. One of ordinary skill in the art isn't going to stick a handle in batter and then grab the handle to cook it, because the handle/batter assembly would fall apart.

Contemplated mechanisms comprise a heating element, wherein the heating element is designed to bake the raw dough or batter product or heat oil to fry the raw dough or batter product to form a baked or fried cake product. Contemplated heating elements may comprise an electric fixture, a gas fixture or a combination thereof. Contemplated heating elements may be an oven, a vat of oil or any other suitable element or combination of elements that can reliably bake or fry a raw dough or batter to produce a final, fully cooked or baked product.

Mechanisms contemplated herein also include a dipping tray, wherein the dipping tray is designed to hold a plurality of the baked or fried cake product. This feature is yet another novel feature of the claimed mechanism in that most automated systems suspend the products individually and either coat them under a waterfall-type of arrangement or dip each one individually. The concept of a dipping tray that holds a plurality of products that are equally and spatially aligned and prepared for dipping is new and not currently done in these types of systems. One reason for that is that there have not been reliable methods of arranging the products in the tray until now.

As mentioned above, contemplated mechanisms comprise a robotic tool, wherein the tool is designed to grab the handle in the baked or fried cake product and move the baked or fried cake product to the dipping tray. In these embodiments, at least 20 products are arranged in the dipping tray. In some embodiments, at least 40 products are arranged in the dipping tray. And in yet other embodiments, at least 70 products are uniformly arranged in the dipping tray.

An open container of a liquid coating material is provided as part of the mechanism or process and is designed to receive the dipping tray that is filled—in whole or in part—by baked or fried products. In some embodiments, there may be more than one open container of a liquid coating material, wherein the products are successively dipped to achieve a thicker coating or to achieve a multi-layer coating. A contemplating coating material is any suitable material that is designed to coat a baked or fried product, dry at a reasonable temperature or during a reasonable processing time and be reliably shelf or storage stable.

A robotic dipping tool is also contemplated, wherein the dipping tool is designed to place the full dipping tray into the container or containers of the liquid coating material or materials and then remove the full dipping tray from the container after the baked or fried cake product is coated.

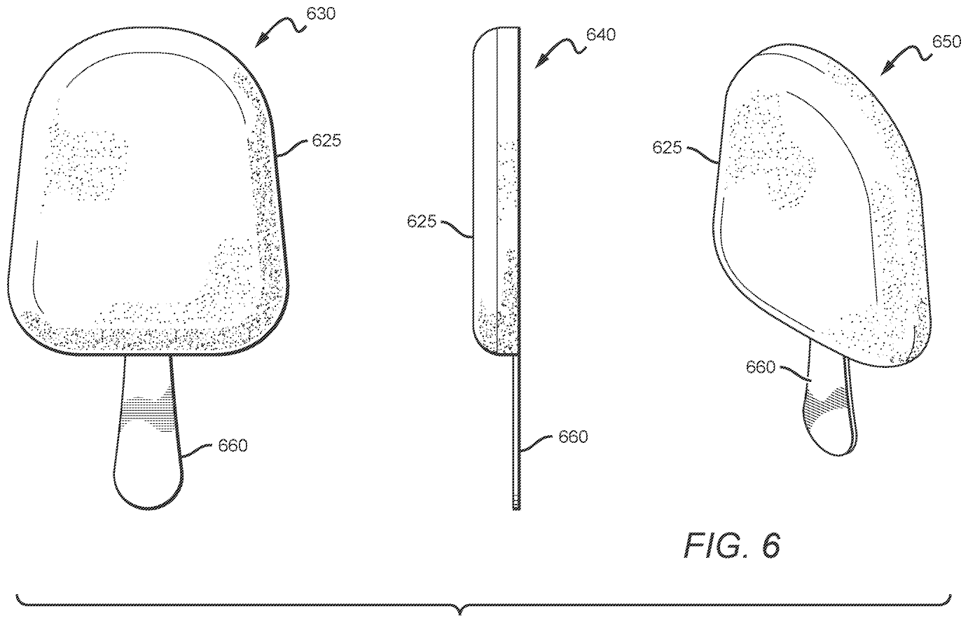

Finally, a drying station is contemplated as a part of the mechanism, wherein the drying station is designed to secure the full dipping tray until the coated baked or fried cake product is dried. A contemplated drying station may comprise refrigeration, blowing air or another gas, or merely providing a stable place where the dipping tray and its contents can be temporarily stored. FIG. 6 shows a contemplated baked or fried cake product 625 from the front 630, the side 640 and from a diagonal perspective 650. The stick 660 is shown in each embodiment as well.

Thus, specific embodiments and methods of systems for producing a baked or fried product, including the methods of production have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1-20. (canceled)

21. A method of producing a baked or fried cake product, comprising:
providing a mold, wherein the mold comprises a top half, a bottom half and an end opening and wherein the mold is designed to hold a raw dough or batter product,
providing a product handle insertion mechanism, wherein a handle, a stick or a post is inserted into the raw dough or batter product,
providing a heating element, wherein the heating element is designed to bake the raw dough or batter product or heat oil to fry the raw dough or batter product to form a baked or fried cake product,
providing a dipping tray, wherein the dipping tray is designed to hold a plurality of the baked or fried cake product,
providing a robotic tool, wherein the tool is designed to grab the handle, the stick or the post in the baked or fried cake product and move the baked or fried cake product to the dipping tray,
providing an open container of a liquid coating material,
providing a robotic dipping tool, wherein the dipping tool is designed to place the full dipping tray into the container of the liquid coating material and then remove the full dipping tray from the container after the baked or fried cake product is coated, and
providing a drying station, wherein the drying station is designed to secure the full dipping tray until the coated baked or fried cake product is dried.

22. The method of claim 21, wherein the product handle insertion mechanism operates to pick up handles, sticks or posts and reliably insert the handle, stick or post in each of the raw dough or batter product.

23. The method of claim 21, further comprising injecting a filling into the raw dough or batter before the handle, stick or post is inserted.

24. The method of claim 21, further comprising injecting a filling into the raw dough or batter before the dough or the batter is baked or fried.

25. The method of claim 21, wherein the mold is rectangular, square, spherical, triangular or a combination of shapes.

26. The method of claim 21, wherein the mold comprises any suitable material, including aluminum, steel, cast iron, non-stick material, composite material or a combination thereof.

27. The method of claim 21, wherein the top half and the bottom half of each mold is independent from one another.

28. The method of claim 21, wherein the end opening of each mold is designed to operatively communicate with the handle.

29. The method of claim 21, wherein the product handle insertion mechanism is fully automated.

30. The method of claim 21, wherein the product handle insertion mechanism is partially automated.

31. The method of claim 21, wherein the dipping tray comprises a plurality of product.
